(19) United States
(12) Patent Application Publication
(10) Pub. No.: US 2024/0279464 A1
(43) Pub. Date: Aug. 22, 2024

(54) THERMOPLASTIC MOULDING COMPOSITION RETAINING HIGH GLOSS

(71) Applicant: BASF SE, Ludwigshafen am Rhein (DE)

(72) Inventors: Rainer XALTER, Lampertheim (DE); Jens CREMER, Ludwigshafen (DE); Martin Robert SCHEUBLE, Ludwigshafen (DE)

(21) Appl. No.: 18/560,695

(22) PCT Filed: Jun. 3, 2022
(86) PCT No.: PCT/EP22/65220

§ 371 Date: Nov. 14, 2023

(30) Foreign Application Priority Data
Jun. 4, 2021 (EP) 21177753.7

(51) Int. Cl. C08L 77/06; B29C 45/00; B29C 48/00; B29K 77/00; B29L 31/30; C08K 5/13; C08K 5/17; C08K 5/526

(52) U.S. Cl. CPC C08L 77/06; B29C 45/0001; B29C 48/022; C08K 5/13; C08K 5/17; C08K 5/526; B29K 2077/00; B29K 2995/0022; B29K 2995/0055; B29K 2995/0087; B29K 2995/0089; B29L 2031/30; C08L 2205/025

(57) ABSTRACT

Disclosed herein is a thermoplastic moulding composition including
a) from 50 to 96.95% by weight of polyamide containing aliphatic non-branched C₁₀₋₁₂ building blocks, selected from polyamide 6.10 and mixtures of polyamide 6.10 with polyamide 6.12, polyamide 12.12, polyamide 11 and/or polyamide 12,
b) from 0 to 37% by weight of further polyamide different from component A);
c) from 3 to 30% by weight of polyamide-polyether block copolymer;
d) from 0.05 to 1.5% by weight of hindered amine light stabilizer,
e) from 0 to 1% by weight of sterically hindered phenol oxidation retarder;
f) from 0 to 20% by weight of further additives,
where the total of the percentages by weight of a) through f) is 100% by weight and the total of the percentages by weight of b) and c) is not more than 40% by weight.

The invention relates to a thermoplastic moulding composition that retains high gloss despite the presence of an impact modifier in the composition. Furthermore, the invention relates to a process for producing the thermoplastic moulding material, the use of the thermoplastic moulding material for producing moulded or extruded articles, to the moulded or extruded articles and a process for producing the moulded or extruded articles as well as the use of polyamide-polyether block copolymers for maintaining high gloss in thermoplastic moulding compositions under exposure to UV light and weathering.

It is known to increase the impact strength and/or elongation at break of polyamides by mixing the polyamides with functionalized elastomers. The tensile modulus may be reduced at the same time.

U.S. Pat. No. 5,482,997 relates to polyamide compositions comprising an elastomer having polyamidereactive groups to increase impact resistance. For example, an ethylene-propylene-ethylidenenorbornene-terpolymer grafted with maleic anhydride or a thermoplastic polymer, based on equal amounts of polypropylene and EPDM rubber, grafted with maleic anhydride is employed.

U.S. Pat. No. 5,602,200 describes polyamide/polyolefin blends comprising an unmodified polypropylene or unmodified polyethylene and optionally also an ethylene-propylene-diene elastomer grafted with carboxylic acid or maleic anhydride.

Often anhydride-modified ethylene copolymers or SEBS are employed as elastomers in polyamides. However, the addition of such elastomers typically leads to a severe decrease in the gloss of moulded parts made of the moulding composition.

U.S. Pat. No. 3,549,724 discloses a polymer blend capable of melt shaping to provide a shaped article having anti-static properties, prepared by melt blending a polyamide and a polyether-polyamide block copolymer. The polyether is based on polyethylene glycol having a number average molecular weight of about 4000 which is reacted to form polyethylene oxide diammonium adipate, which subsequently is mixed and reacted with caprolactam. The resulting polyether-polyamide block copolymers were mixed with nylon 6 polymer or nylon 66 polymer. The polyether-polyamide block copolymer imparts antistatic properties to the polyamide composition.

WO 2020/173866 A1 discloses thermoplastic moulding compositions containing a mixture of polyamide 6 or polyamide 6/6.6 and polyamide 6.10. Further polymers can be employed in the composition, which, however, is less preferred.

WO 2020/178342 discloses thermoplastic moulding compositions comprising polyamide 6.10, polyamide 6 and/or polyamide 6/6.6. Further polymers can be employed in the moulding composition.

US 2006/0014035 A1 discloses combinations of nylon-11, nylon-10/12 with IPDA, copolymers of PA-12 and PTMG and stabilizers Tinuvin 312 and Tinuvin 770. It is stated that the compositions may include thermal stabilizers, antioxidants and UV stabilizers. As a possible flexible polyamide (C), PA-6/6.6 is mentioned. PA-6.10 is mentioned as a possible aliphatic polyamide. It is stated that the flexible polyamide (C) can be a copolymer of polyamide blocks and polyether blocks, and copolyamides. The finished part has a three-layer structure on a substrate, wherein the upper layer is PA-11. For the upper layer, it is described that it can provide a shiny surface finish, among other appearances as matte or grained.

US 2018/0171140 A1 discloses compositions comprising polyamide 11, polyamide-polyether block copolymers having PA-11 blocks and PTMG blocks, phosphite-type antioxidants and hindered phenol antioxidants. One example is shown in Table 1. PA-6.10 is mentioned as an alternative for PA-11. The combination of polyamide and impact modifier gives a compromise between rigidity, impact and reverse bending strength and an optimized fluidity. Optical properties are not mentioned but molded parts devoid of transparency are mentioned.

The object underlying the present invention is to provide moulding materials based on polyamide having aliphatic non-branched C₁₀₋₁₂ building blocks that are impact-modified, but retain high gloss despite the impact modifier addition. Furthermore, the moulded parts shall have high resistance against UV light and weathering and shall be suitable for producing vehicle exterior moulded parts.

The objects are achieved by a thermoplastic moulding composition comprising
a) from 50 to 96.95% by weight of polyamide containing aliphatic non-branched C₁₀₋₁₂ building blocks, preferably polyamide 6.10 or mixtures of polyamide 6.10 with polyamide 6.12, polyamide 12.12, polyamide 11 and/or polyamide 12, as component A),
b) from 0 to 37% by weight of further, preferably aliphatic, polyamide different from component A), as component B),
c) from 3 to 30% by weight of polyamide polyether block copolymer, as component C),
d) from 0.05 to 1.5% by weight of hindered amine light stabilizer, as component D),
e) from 0 to 1% by weight of sterically hindered phenol oxidation retarder, as component E), from 0 to 20% by weight of further additives, as component F), f)
where the total of the percentages by weight of components A) to F) is 100% by weight and the total of the percentages by weight of components B) and C) is not more than 40% by weight.

Preferred is an amount of from 0.05 to 1% by weight of component E) and an amount of from 50 to 96.9% by weight of component A).

The objects are furthermore achieved by a process for producing the thermoplastic moulding material by mixing the components A) to F).

The objects are furthermore achieved by use of the thermoplastic moulding material for producing moulded articles and extruded profiles.

The objects are furthermore achieved by a fibre, film or moulded article made of the thermoplastic moulding material.

The objects are furthermore achieved by a process for producing fibres, films or moulded articles by extrusion, injection moulding or blow moulding of the thermoplastic moulding material.

The objects are furthermore achieved by use of polyamide-polyether block copolymers in thermoplastic molding compositions comprising aliphatic non-branch C₁₀₋₁₂ building blocks for maintaining high gloss of the impact-modified thermoplastic moulding composition.

According to the present invention it has been found that the use of polyamide-polyether block copolymers allows for polyamides based on non-branched C₁₀₋₁₂ building blocks to be impact-modified and retain high gloss at the same time. Furthermore, moulded parts have a high UV resistance and heat resistance.

As component A), from 50 to 96.9% by weight, preferably from 60 to 95% by weight, more preferably from 65 to 90% by weight of one or more polyamides containing aliphatic non-branched C₁₀₋₁₂ building blocks are employed. It can be a, preferably aliphatic, homopolyamide or copolyamide. For example, a part or the whole amount of dicarboxylic acid and/or diamine can be aliphatic non-branched C₁₀₋₁₂ dicarboxylic acid or aliphatic non-branched C₁₀₋₁₂ diamine. Thus, aliphatic non-branched terminal C₁₀₋₁₂ dicarboxylic acids or -diamines are preferred. Furthermore, corresponding C₁₀₋₁₂ lactams or aminonitriles can be employed, which lead to the respective building blocks of the polyamide. Preferably, the total amount of diamine or dicarboxylic acid is aliphatic non-branched terminal C₁₀₋₁₂ diamine or dicarboxylic acid. Most preferably, the polyamide is selected from polyamide 6.10, polyamide 6.12, polyamide 12.12, polyamide 11, polyamide 12 or mixtures thereof. Especially preferred is polyamide 6.10.

When the polyamide does not only contain aliphatic non-branched C₁₀₋₁₂ building blocks, the other building blocks are preferably C₄₋₁₂ building blocks, more preferably C₆₋₁₂ building blocks, which preferably are also aliphatic and non-branched and more specifically terminal.

The polyamide 6.10 preferably has a VZ=120 to 250 mL/g, determined according to DIN ISO 307 (2007/2008).

When mixtures containing polyamide 6.10 are employed as component A), the mixing ratio by weight of polyamide 6.10 to the further polyamides is preferably 50:50 to 99:1, more preferably 60:40 to 90:10, most preferably 70:30 to 80:20.

As component B), 0 to 37% by weight, more preferably 0 to 20% by weight, most preferably 0 to 15% by weight of further, preferably aliphatic, polyamides different from component A) are employed. Preferred are polyamide 6, polyamide 6.6, polyamide 6.6/6, polyamide 6/6.6 and mixtures thereof. Preferably, component B) is polyamide 6.6/6. Preferably, component B) has a viscosity number in the range of from 80 to 200 ml/g, more preferably 100 to 180 ml/g, specifically 120 to 170 ml/g, determined as a 0.5 wt % solution in 96 wt % sulphuric acid at 25° C. according to ISO 307.

Component C) is present in an amount of from 3 to 30% by weight, preferably 4 to 25% by weight, more preferably 5 to 20% by weight.

Component C) is a polyamide-polyether block copolymer.

The weight ratio of polyamide and polyether blocks is preferably in the range of from 1:9 to 9:1, more preferably 2:8 to 8:2.

The polyamide block preferably is linear aliphatic polyamide, more preferably a linear aliphatic polyamide based on C₄₋₁₂ building blocks. It can be based on dicarboxylic acid/diamine mixtures and/or lactams or aminonitriles.

The polyether blocks can be chosen from all suitable polyethers which can be reacted with polyamides. For example, the polyether block can be based on polyethylene glycol as disclosed in U.S. Pat. No. 3,549,724. Preferred is a polyether block which is based on polytetramethylene ether glycol (PTMEG, PolyTHF) or contains at least 90% repeating units of C₄ ether units, more preferably PolyTHF units.

The polyamide-polyether block copolymer preferably has a melting point in the range of from 120 to 220° C., more preferably 140 to 200° C., determined according to ISO 11357. The shore D hardness is preferably is in the range of from 20 to 65, more preferably from 25 to 60, determined according to ISO 868.

Suitable preferred polyamide-polyester block copolymers can be obtained from Arkema as different grades of Pebax®, preferred are for example Pebax® 3533 SA 01 or Pebax® HD 5513 SA 01.

Pebax® is a thermoplastic elastomer (TPE-A) or a flexible polyamide without softener which is composed of a regular linear chain of polyamide segments and flexible polyether segments. Pebax® grades are block copolymers obtained e.g. by polymerization of a lactam monomer (e.g. ε-caprolactam, laurolactam) in presence of an amino-terminated polyether (e.g. PolyTHF, polyethylene glycol PEG).

The blend of components A) and C) and/or components A), B) and C) and/or components A) to F), preferably has a flexural modulus of from larger than 1000 to 2000 MPa, more preferably of from 1010 to 1750 MPa, most preferably of from 1020 to 1500 MPa, as determined according to standard ISO 178:2010.

As component D), 0.05 to 1.5% by weight, preferably 0.1 to 1.0% by weight, most preferably 0.2 to 0.8% by weight of one or more hindered amine light stabilizers are employed as component D).

Hindered amine light stabilizers (HALS) are a class of stabilizers for long-term protection of polymers against heat and UV irradiation. HALS are very effective inhibitors against free radicalinduced degradation of polymers at low and medium temperatures. This class of amine stabilizers is based on 2,2,6,6-tetramethylpiperidine derivatives. HALS can be categorized according to the molecular weight. HALS with molecular weight of 200 to 500 g/mol are commonly referred to as low MW HALS. Compounds having a molecular weight of at least 2000 g/mol are referred to high MW HALS.

Suitable HALS can be obtained e.g. from Clariant -, for example Nylostab® S-EED.

As component E), from 0 to 1% by weight, and, if present, from 0.05 to 1% by weight, preferably from 0.1 to 0.5% by weight, most preferably from 0.1 to 0.3% by weight of one or more sterically hindered phenol oxidation retarders are employed.

Suitable sterically hindered phenols are in principle all of the compounds which have a phenolic structure, and which have at least one bulky group on the phenolic ring.

It is preferable to use, for example, compounds of the formula

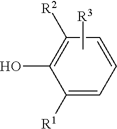

where:

R¹ and R² are an alkyl group, a substituted alkyl group, or a substituted benzyl group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, substituted hydroxyphenyl carboxylic acids, in particular from substituted benzenepropionic acids or substituted hydroxyphenyl propionic acids.

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate](Irganox® 1010), and also N,N′-hexamethylenebis-3,5-di-tert-butyl-4-hydroxyhydrocinnamide (Irganox® 1098), and octadecyl-3-[3,5-di-tert-butyl-4-hydroxyphenyl]propionate](Irganox® 1076).

As component F), from 0 to 20% by weight, preferably from 0 to 15% by weight, most preferably from 0 to 10% by weight of further additives are employed.

Among further additives, phosphites as secondary oxidation retarders can be specifically mentioned. Preferably, 0.05 to 1% by weight, more preferably 0.1 to 0.5% by weight, most preferably 0.1 to 0.3% by weight of phosphites, based on the total of the percentages by weight of components A) to F), are employed.

The total amount of these phosphites of component F) and of component E) are preferably in the range of from 0.1 to 1.5% by weight, more preferably 0.2 to 1% by weight, most preferably 0.3 to 0.7% by weight, based on the total of the percentages by weight of components A) to F).

The secondary oxidation retarders have a synergistic effect in combination with the sterically hindered phenol oxidation retarders (component E)).

Phosphites employed as secondary oxidation retarder in combination with component E) are preferably phosphite esters derived from organic hydroxy compounds. The phosphite esters are preferably derived from substituted phenols, preferably contain sterically hindering substituents, specifically alkyl substituents. One example is di-tert-butylphenol, giving tris(2,4-di-tert.-butylphenyl)phosphite as a preferred secondary oxidation retarder. This compound can be obtained by BASF SE under the name Irgafos® 168.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, diisodecyloxy pentaerythritol diphosphite, bis(2,4-ditert-butyl-6-methylphenyl) pentaerythritol diphosphite, bis(2,4,6-tris(tert-butylphenyl)) pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl) methyl phosphite and bis(2,4-di-tert-butyl-6-methylphenyl) ethyl phosphite. In particular, preference is given to tris[2-tert-butyl-4-thio(2′-methyl-4′-hydroxy-5′-tert-butyl)phenyl-5-methyl]phenyl phosphite and tris(2,4-di-tert-butylphenyl) phosphite (Irgafos® 168: product commercially available from BASF SE).

Component F) can comprise additional polymers different from components A), B) and C). Preferably, component F) contains not more than 10% by weight, more preferably not more than 5% by weight, based on the total of the percentages by weight of components A) to F) of such further polymers. Preferably, possible further polymers can be selected from polyamides different from components A) and B), as for example described in WO 2020/173866 on pages 9 to 11.

Examples of these are polyamides that derive from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 4 to 40, preferably from 6 to 12, in particular from 6 to 10, carbon atoms, and aromatic dicarboxylic acids. Merely as examples, those that may be mentioned here are adipic acid, azelaic acid, sebacic acid, dodecanedioic acid and terephthalic and/or isophthalic acid.

Particularly suitable diamines are alkanediamines having from 4 to 12, in particular from 6 to 8, carbon atoms, and also m-xylylenediamine, di(4-aminophenyl)methane, di(4-aminocyclohexyl)methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from w-aminoalkylnitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6T/6 and PA 6T/66, where the triamine content of these is less than 0.5% by weight, preferably less than 0.3% by weight (see EP-A 299 444). Other polyamides resistant to high temperatures are known from EP-A 19 94 075 (PA 6T/61/MXD6).

The following list, which is not comprehensive, comprises the polyamides A) and other polyamides B) for the purposes of the invention, and the monomers comprised:

### Ab Polymers:

PA 4 Pyrrolidone
PA 6 ε-Caprolactam
PA 7 Ethanolactam
PA 8 Caprylolactam
PA 9 9-Aminopelargonic acid
PA 11 11-Aminoundecanoic acid
PA 12 Laurolactam

### Aa/Bb Polymers:

PA 46 Tetramethylenediamine, adipic acid
PA 56 Pentamethylenediamine, adipic acid
PA 510 Pentamethylenediamine, sebacic acid
PA 512 Pentamethylenediamine, decanedicarboxylic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1, 12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 9T Nonamethylenediamine, terephthalic acid

### AA/Bb Polymers:

PA 61 Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 61/6T, PA 6T/61 (see PA 61 and PA 6T)
PA PACM 12 Diaminodicyclohexylmethane, laurolactam
PA 61/6T/PACM as PA 61/6T+diaminodicyclohexylmethane
PA 6/6.36 Caprolactam/hexamethylenediamine, C₃₆-dicarboxylic acid
PA 6T/66 (see PA 6T and PA 66)
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Most preferred are PA 6, PA 66, PA 6/66, PA 66/6, PA 6/6.36, PA 61/6T, PA 6T/61, PA 9T and PA 6T/66.

Among the above-mentioned polyamides are also those of components A) and B).

Concomitant use can be made of further polymers in addition to the polyamide.

The thermoplastic polymers different from component A are preferably selected from
homo- or copolymers which comprise, incorporated into the polymer, at least one monomer selected from C₂-C₁₀ monoolefins, for example ethylene or propylene, 1,3-butadiene, 2-chloro-1,3-butadiene, vinyl alcohol and C2-C10-alkyl esters thereof, vinyl chloride, vinylidene chloride, vinylidene fluoride, tetrafluoroethylene, glycidyl acrylate, glycidyl methacrylate, acrylates and methacrylates having alcohol components derived from branched or unbranched C1-C10 alcohols, vinylaromatics, for example styrene, acrylonitrile, methacrylonitrile, a, ß-ethylenically unsaturated mono- and dicarboxylic acids, and maleic anhydride,
homo- and copolymer of vinylacetals,
polyvinyl esters,
polycarbonates (PC),
polyesters, for example polyalkylene terephthalates, polyhydroxyalkanoates (PHA), polybutylene succinates (PBS), polybutylene succinate adipates (PBSA),
polyethers,
polyetherketones,
thermoplastic polyurethanes (TPU),
polysulfides,
polysulfones,
polyether sulfones,
cellulose alkyl esters
and mixtures thereof.

Mention may be made by way of example of polyacrylates having identical or different alcohol moieties from the group of the C4-C8 alcohols, particularly of butanol, hexanol, octanol and 2-ethylhexanol, polymethyl methacrylate (PMMA), methyl methacrylate-butyl acrylate copolymers, acrylonitrile-butadiene-styrene copolymers (ABS), ethylene-propylene copolymers, ethylenepropylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinylbutyral (PVB), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP) and cellulose acetate/butyrate (CAB).

Furthermore, in addition to component C), smaller amounts of further elastomers may be employed, most preferably, no further elastomers are employed.

Some preferred types of such elastomers are described below.

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, vol. 14/1 (Georg-Thieme-Verlag, Stuttgart, Germany, 1961), pages 392 to 406, and in the monograph by C. B. Bucknall, “Toughened Plastics” (Applied Science Publishers, London, U K, 1977).

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricycledienes, such as 3-methyltricyclo[5.2.1.02.6]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These dicarboxylic acid derivatives or monomers comprising epoxy groups are preferably incorporated into the rubber by adding to the monomer mixture monomers comprising dicarboxylic acid groups and/or epoxy groups and having the general formulae I or Il or III or IV

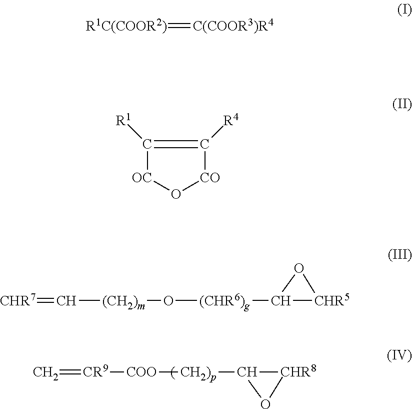

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as, for example, n-butyl acrylate and 2-ethylhexyl acrylate, corresponding methacrylates, butadiene and isoprene, and also mixtures of these. These monomers may be copolymerized with other monomers, such as, for example, styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, «-methylstyrene, p-methylstyrene, or acrylates or methacrylates, such as methyl acrylate, ethyl acrylate or methyl methacrylate. Besides these, it is also possible to use relatively small proportions of other comonomers.

It is advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

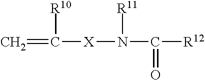

where the substituents can be defined as follows:
R¹⁰ is hydrogen or a C1-C₄-alkyl group,
R¹¹ is hydrogen, a C1-C8-alkyl group or an aryl group, in particular phenyl,
R¹² is hydrogen, a C1-C10-alkyl group, a C6-C12-aryl group, or —OR13,
R¹³ is a C1-C8-alkyl group or a C6-C12-aryl group, which can optionally have substitution by groups that comprise O or by groups that comprise N,
X is a chemical bond, a C1-C10-alkylene group, or a C6-C12-arylene group, or

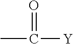

Y is O—Z or NH—Z, and
Z is a C1-C10-alkylene or C6-C12-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl methacrylate |
| | acrylate, ethylhexyl acrylate, or a | |
| | mixture of these | |
| II | as I, but with concomitant use of | as I |
| | crosslinking agents | |
| III | as I or II | n-butyl acrylate, ethyl acrylate, methyl acrylate, |
| | | 1,3-butadiene, isoprene, ethylhexyl acrylate |
| IV | as I or II | as I or III, but with concomitant use of monomers |
| | | having reactive groups, as described herein |
| V | styrene, acrylonitrile, methyl meth- | first envelope composed of monomers as |
| | acrylate, or a mixture of these | described under I and II for the core, second |
| | | envelope as described under I or IV for the |
| | | envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

The thermoplastic molding compositions of the invention can comprise, as component F), conventional processing aids, such as (further) stabilizers, (further) oxidation retarders, (further) agents to counteract decomposition by heat and decomposition by ultraviolet light, lubricants and mold-release agents, colorants, such as dyes and pigments, nucleating agents, plasticizers, flame retardants, etc.

The molding compositions of the invention can comprise from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising the polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Examples of oxidation retarders and heat stabilizers are besides the sterically hindered phenols (E)) HALS amines (e.g. TAD) (D)), phosphites (F)), hydroquinones, aromatic secondary amines, such as diphenylamines, various substituted members of these groups, and mixtures of these, in concentrations of up to 1% by weight, based on the weight of the thermoplastic molding compositions.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones, benzimidazolone colorants and perinone colorants.

The molding compositions of the invention can comprise from 0.05 to 5% by weight, preferably from 0.1 to 2% by weight, and in particular from 0.25 to 1.5% by weight, of a nigrosine.

Nigrosines are generally a group of black or gray phenazine dyes (azine dyes) related to the indulines and taking various forms (water-soluble, oil-soluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosines are obtained industrially via heating of nitrobenzene, aniline, and aniline hydrochloride with metallic iron and FeCl₃ (the name being derived from the Latin niger=black).

They can be used in the form of free base or else in the form of salt (e.g. hydrochloride).

Further details concerning nigrosines can be found by way of example in the electronic encyclopedia Rompp Online, Version 2.8, Thieme-Verlag Stuttgart, 2006, keyword “Nigrosine”.

As a further component of the molding composition of the invention, UV stabilizers may be mentioned, the amounts of which used are generally up to 2% by weight, based on the molding composition, are various substituted resorcinols, salicylates, benzotriazoles, benzophenones, benzoates, and hydroxyphenyl triazines.

Materials that can be used as nucleating agents are sodium phenylphosphinate, aluminum oxide, silicon dioxide, and also preferably talc.

Preferably, the thermoplastic moulding composition does not contain fibrous or particulate fillers for reinforcing the moulding composition. However, colouring pigments may be present. Specifically, fibrous fillers like glass fibres, carbon fibres, aramid fibres are preferably not employed in the thermoplastic moulding composition, thus they are free of these fibrous fillers.

Furthermore, preferably no mineral fillers are present in the thermoplastic moulding compositions.

The thermoplastic moulding compositions of the invention can be produced by processes known per se, by mixing the starting components in conventional mixing apparatus, such as screw-based extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The mixing temperatures are generally from 230 to 320° C.

The examples were performed on black-coloured compounds. Black is a very critical colour especially with regard to wash cycle and UV resistance since surface deterioration can most readily be seen on black surfaces.

### Materials

PA 6.10: Zytel® RS LC3060 NC010 of DuPont or Radipol® DC45D (Comp.Ex.4) of RadiciGroup
PA 66/6: Ultramid® 9A of BASF
PA 6: Ultramid® B of BASF
PA 11: Rilsan® BMNO TLD of Arkema
Anhydride-modified ethylene copolymer: FUSABOND® N 598 of DuPont
SEBS: Kraton® FG 1901 GT of Kraton Polymers
Polyamide-polyether block copolymer 1: Pebax® 3533 SP 01 of Arkema, Shore hardness 33D
Polyamide-polyether block copolymer 2: Pebax® HD 5513 SA 01 of Arkema, Shore hardness 58D
Phenolic antioxidant: Irganox® 1098 of BASF SE
Phosphite antioxidant: Irgafos® 168 of BASF SE
HALS (hindered amine light stabilizer): Nylostab® S-EED of Clariant
Carbon black: Black Pearls 1180-HD of Cabot
PE wax: Luwax® OA 5 of BASF SE

### Characterization

Notched impact strength: ISO 179/1eU
Gloss determination according to DIN EN ISO 2813 (2015)
Colour determination and geometry 45°/0° according to DIN 53236 on Hunter LabScan XE
Visual grey scale determination according to DIN EN 20105-A02 (1994)
Road salt resistance according to Daimler DBL 5416 (2017-07), Chapter 8.3
Artificially accelerated UV weathering:
   PV3929 (2018-03): ATLAS Ci5000; irradiance 0.60 W/m² at 340 nm, black standard temperature 90° C., relative humidity 20%+10%, cycle: continuously without spray
   ISO 4892-2A (2009-11): ATLAS Ci5000; irradiance 0.51 W/m² at 340 nm, black standard temperature 65° C., relative humidity 50%+10%, cycle: 102 min irradiation, 18 min irradiation with water spray
   SAE J 2527-C₁ (2017): ATLAS Ci5000; irradiance 0.55 W/m² at 340 nm, black standard temperature 70° C., relative humidity 50%+10% (light cycle), 90-100% (dark cycle), cycle: 1) 40 min irradiation; 2) 20 min irradiation with water spray; 3) 60 min irradiation; 4) 60 min water spray without irradiation

The surface and optical properties were established after washing the test specimen with aqueous surfactant and sponge.

Car wash resistance was determined according to DIN EN ISO 20566 (2013-06).

The Erichsen scratch test was performed according to the Volkswagen standard PV3952 (2002-08) using an Erichsen scratch device model 430 equipped with a needle of 1 mm ball diameter at 10 N force and 1000 mm/min. A cross grid was scratched with a line distance of 2 mm. Deviating from the optical evaluation described in the standard, the average scratch depth (parallel and orthogonal to the injection molding direction) was determined by means of a Bruker Dektak XT profilometer as the color measurement did not allow for significant differentiation between the samples.

The compounds were prepared by melt mixing the different components in a twin screw extruder ZSK 26 MC of Coperion at 50 kg/h and 320° ° C. The obtained extrudates were cooled and granulated.

The test specimen were obtained according to ISO 179-2/1eA using an injection molding machine Arburg 420C at a polymer temperature of 280° C. and a tool temperature of 100° ° C. Plates having a dimension of 60×60×2 mm³ were prepared by employing a polished counter plate for the gloss and car wash tests.

The results are summarized in Table 1.

TABLE 1

| | | Comp. | Comp. | Comp. | Comp. | | |
|---|---|---|---|---|---|---|---|
| | | Ex. 1 | Ex. 2 | Ex. 3 | Ex. 4 | Ex. 1 | Ex. 2 |
| PA 6.10 | | 81.9 | 90.2 | 92.2 | | 81.9 | 81.9 |
| PA 66/6 | | 16.3 | | | | 8.8 | |
| PA 6 | | | | | 5.4 | | |
| PA 11 | | | | | 75.9 | | |
| Anhydride-modified | | | 8 | | | | |
| ethylene copolymer | | | | | | | |
| SEBS | | | | 6 | | | |
| Polyamide polyether | | | | | | 7.5 | |
| block copolymer 1 | | | | | | | |
| Polyamide polyether | | | | | 16.3 | | 16.3 |
| block copolymer 2 | | | | | | | |
| Phenolic antioxidant | | 0.2 | 0.2 | 0.2 | 0.2 | 0.2 | 0.2 |
| Phosphite antioxidant | | 0.2 | 0.2 | 0.2 | 0.2 | 0.2 | 0.2 |
| HALS | | 0.3 | 0.3 | 0.3 | 0.3 | 0.3 | 0.3 |
| Carbon black | | 0.6 | 0.6 | 0.6 | 0.6 | 0.6 | 0.6 |
| PE wax | | 0.5 | 0.5 | 0.5 | 0.5 | 0.5 | 0.5 |
| Charpy notched, dry as molded, | | 4.7 | 8.2 | 9.3 | n/d | 7.8 | 8.6 |
| 23° C. (kJ/m²) | | | | | | | |
| Road salt resistance test | | no | no | no | no | no | no |
| acc. to DBL 5416, 8.3 | | damage | damage | damage | damage | damage | damage |
| Gloss 20° angle | | 92 | 54 | 66 | 86 | 90 | 91 |
| (gloss units) | | | | | | | |
| UV | Gloss 20° angle | 91 | n/d | n/d | n/d | 100 | 94 |
| resistance | (gloss units) | | | | | | |
| acc. to | Visual grey scale | 3.5 | n/d | n/d | n/d | 4.5 | 4 |
| PV3929, | rating | | | | | | |
| 1500 h | Crack | very | n/d | n/d | n/d | weak | none |
| exposure | formation | strong | | | | | |
| UV | Gloss 20° angle | 73.2 | n/d | n/d | n/d | 76.9 | 84.9 |
| resistance | (gloss units) | | | | | | |
| acc. to ISO | Visual grey scale | 3.5 | n/d | n/d | n/d | 4 | 4 |
| 4892-2A, | rating | | | | | | |
| 1600 h | Crack | none | n/d | n/d | n/d | none | none |
| exposure | formation | | | | | | |
| UV | Gloss 20° angle | 16.5 | n/d | n/d | n/d | 47.1 | 58.4 |
| resistance | (gloss units) | | | | | | |
| acc. to ISO | Visual grey scale | 1 | n/d | n/d | n/d | 2.5 | 3 |
| 4892-2A, | rating | | | | | | |
| 3200 h | Crack | none | n/d | n/d | n/d | none | none |
| exposure | formation | | | | | | |
| UV | Gloss 20° angle | n/d | n/d | n/d | n/d | n/d | 80 |
| resistance | (gloss units) | | | | | | |
| acc. to SAE J | Visual grey scale | n/d | n/d | n/d | n/d | n/d | 3.5 |
| 2527-C1, | rating | | | | | | |
| 2500 kJ/m² | Crack | n/d | n/d | n/d | n/d | n/d | none |
| exposure | formation | | | | | | |

| | | | | | | |
|---|---|---|---|---|---|---|
| Gloss retention (20°) after car | 29 | n/d | n/d | 12.2 | 28 | 36 |
| wash test (%) | | | | | | |
| Average scratch depth (nm) after | | | | 2.05 | | 1.34 |
| Erichsen scratch test (10N) | | | | | | |

From the results it is evident that Comp. Ex. 1 shows good road salt resistance, car wash resistance and tensile strength. UV resistance is not sufficient, and gloss is significantly degraded.

Examples 1 and 2 show significantly improved resistance in artificially accelerated weathering. Nearly no crack formation and a significantly improved gloss after weathering are achieved. Road salt resistance is high. Furthermore, the notched impact strength of inventive Examples 1 and 2 is significantly improved in comparison to reference Comp. Ex. 1.

Furthermore, Comp. Ex. 4 shows inferior scratch resistance (Erichsen scratch test and car wash test) in comparison to the inventive Example Ex. 2.

1. A thermoplastic moulding composition comprising a) from 50 to 96.9% by weight of polyamide comprising aliphatic non-branched C₁₀₋₁₂ building blocks, selected from the group consisting of polyamide 6.10 and mixtures of polyamide 6.10 with polyamide 6.12, polyamide 12.12, polyamide 11 and polyamide 12 as component A),
b) from 0 to 37% by weight of further polyamide different from component A);
c) from 3 to 30% by weight of polyamide-polyether block copolymer, as component C),
d) from 0.05 to 1.5% by weight of hindered amine light stabilizer, as component D),
e) from 0 to 1% by weight of sterically hindered phenol oxidation retarder, as component E), and
f) from 0 to 20% by weight of further additives, as component F),
wherein the total of the percentages by weight of components A) to F) is 100% by weight and the total of the percentages by weight of components B) and C) is not more than 40% by weight;
and wherein
the further polyamide different from component A) is selected from the group consisting of polyamide 6, polyamide 6.6, polyamide 6.6/6, polyamide 6/6.6 and mixtures thereof, and,
wherein component C) contains blocks of PolyTHF and linear aliphatic polyamide, in a weight ratio of 1:9 to 9:1.

2. The moulding composition according to claim 1, wherein component A) has a polyamide 6.10 content of at least 50% by weight.

3. The moulding composition according to claim 1, wherein component B) is polyamide 6.6/6.

4. (canceled)

5. The moulding composition according to claim 1, wherein component E) is present in an amount of from 0.05 to 1% by weight.

6. The moulding composition according to claim 1, wherein the amount of component C) is from 4 to 25% by weight.

7. The moulding composition according to claim 1, wherein the amount of component B) is from 0 to 20% by weight.

8. The moulding composition according to claim 1, wherein component F) comprises 0.05 to 1% by weight, based on the total of the percentages by weight of components A) to F), of phosphites as secondary oxidation retarder.

9. The moulding composition according to claim 1, wherein the total of the percentages by weight of components B) and C) is not more than 30% by weight based on the total of the percentages by weight of components A) to F) which is 100% by weight.

10. The moulding composition according to claim 1, wherein component F) contains not more than 10% by weight based on the total of the percentages by weight of components A) to F) which is 100% by weight, of polymers different from components A), B) and C).

11. A process for producing a thermoplastic moulding material according to claim 1, comprising mixing the components A) to F).

12. A method of using the thermoplastic moulding material according to claim 1, wherein the method comprises using the thermoplastic moulding material for producing moulded articles and extruded profiles.

13. A moulded or extruded article made of a thermoplastic moulding material according to claim 1.

14. A process for producing moulded or extruded articles, the process comprising injection moulding or extruding the thermoplastic moulding material according to claim 1.

15. A method of using 3 to 30% by weight of polyamide-polyether block copolymer, as component C) in thermoplastic moulding compositions comprising
a) from 50 to 96.9% by weight of polyamide containing aliphatic non-branched C₁₀₋₁₂ building blocks, selected from the group consisting of polyamide 6.10 and mixtures of polyamide 6.10 with polyamide 6.12, polyamide 12.12, polyamide 11 and polyamide 12 as component A),
b) from 0 to 37% by weight of further polyamide different from component A);
d) from 0.05 to 1.5% by weight of hindered amine light stabilizer, as component D),
e) from 0 to 1% by weight of sterically hindered phenol oxidation retarder, as component E),
f) from 0 to 20% by weight of further additives, as component F),
wherein the total of the percentages by weight of components A) to F) is 100% by weight and the total of the percentages by weight of components B) and C) is not more than 40% by weight, wherein the method comprising using the polyamide-polyether block copolymer, as component C) for maintaining high gloss of the impact-modified thermoplastic moulding composition;
and wherein
the further polyamide different from component A) is selected from the group consisting of polyamide 6, polyamide 6.6, polyamide 6.6/6, polyamide 6/6.6 and mixtures thereof, and,
wherein component C) contains blocks of PolyTHF and linear aliphatic polyamide, in a weight ratio of 1:9 to 9:1.

16. The moulding composition according to claim 1, wherein the amount of component C) is from 5 to 20% by weight.

17. The moulding composition according to claim 1, wherein the amount of component B) is from 0 to 15% by weight.

18. The moulding composition according to claim 1, wherein the total of the percentages by weight of components B) and C) is not more than 25% by weight, based on the total of the percentages by weight of components A) to F) which is 100% by weight.

19. The moulding composition according to claim 1, wherein component F) comprises not more than 5% by weight, based on the total of the percentages by weight of components A) to F) which is 100% by weight, of polymers different from components A), B) and C).
